(19) United States
(12) Patent Application Publication
(10) Pub. No.: US 2014/0207340 A1
(43) Pub. Date: Jul. 24, 2014

(54) ADAPTIVE CRASH STRUCTURE FOR A VEHICLE AND ASSOCIATED VEHICLE

(71) Applicant: Audi AG, Ingolstadt (DE)

(72) Inventors: Peter Kunsch, Karlskron (DE); Carsten Klinkert, Hitzhofen (DE); Keith Sharp, Ingolstadt (DE); Stefan Uhlar, Ingolstadt (DE)

(73) Assignee: Audi AG, Ingolstadt (DE)

(21) Appl. No.: 14/158,309

(22) Filed: Jan. 17, 2014

(30) Foreign Application Priority Data
Jan. 21, 2013 (DE) 10 2013 000 963.4

(51) Int. Cl. B60R 21/0134

(52) U.S. Cl. CPC B60R 21/0134
USPC 701/45

(57) ABSTRACT

An adaptive crash structure for a vehicle includes a deformation element arranged in a region of a wheel housing of the vehicle, and an interruption system, wherein the deformation element and the interruption system are constructed so as to be able to change from a deactivated state to an activated state, wherein in the deactivated state the deformation element permits movement of a wheel housed in the wheel housing, and wherein in the activated state the deformation element causes the wheel to assume a predetermined position and the interruption system prevents a change of the position of the wheel to be transmitted to a steering wheel.

### CROSS-REFERENCES TO RELATED APPLICATIONS

This application claims the priority of German Patent Application, Serial No. 10 2013 000 963.4, filed Jan. 21, 2013, pursuant to 35 U.S.C. 119(a)-(d), the disclosure of which is incorporated herein by reference.

### BACKGROUND OF THE INVENTION

The invention relates to an adaptive crash structure for a vehicle.

The following discussion of related art is provided to assist the reader in understanding the advantages of the invention, and is not to be construed as an admission that this related art is prior art to this invention.

These types of adaptive crash structures for vehicles are known in numerous variations and are used for absorbing forces occurring during a crash. The known crash structures of a vehicle are configured for a frontal impact, with an overlap to the crash partner of 100% or minimally 40%. In these overlaps the occurring forces can for example be absorbed via the bumper and the longitudinal members of the impacted vehicle by deformation of these structures. In the case of a crash with low overlap such as 25%, an interaction of the longitudinal members is excluded. Therefore the occurring forces may bypass the crash structure and be conducted into the foot space of the vehicle via the wheel rim. For these cases, the crash structures have energy absorbing components, which are constructed as airbag and in the inflated state are capable of absorbing forces that occur in case of an impact.

Steering systems are also known which interrupt a transmission path between a steering wheel and a servo unit. In an accident the servo unit can overtake the steering of the wheels without the driver being able to intervene during an accident in the control of the wheel position via the steering wheel. This allows reducing a risk of injury to the driver which may result from an abrupt change of the position of the wheels and an associated change of direction of the steering wheel.

From DE 198 35 705 A1 a vehicle body for a vehicle is known with a passenger compartment and a support structure connected to the passenger compartment for mounting vehicle components and for absorbing impact energy acting upon the vehicle, and with front and rear wheels which are each surrounded by a wheel housing. The respective wheel housing borders in the longitudinal direction of the vehicle on one side at a side sill and on the opposite side is spaced apart by a hollow space from a bumper, which extends in the transverse direction of the vehicle. In the described vehicle body, the respective hollow space, which borders at the bumper is provided, at least at the height of the bumper, with an energy absorbing component. On the opposite side, a deformation element is arranged at the height of the side sill and/or at the height of a longitudinal member, and protrudes so far into the free space of the wheel housing so as to allow free mobility of the wheel. This makes it possible that in the case of a crash the wheels impact the respective side sill in a defined manner, whereby the energy absorption capacity by the sill can be increased. The deformation elements and/or the energy absorbing components can be configured as airbag or impact energy absorbing elements, which are made of plastic and/or metal, in particular lightweight metal, in form of foam and/or including a honeycomb structure or an appropriate profiling.

From DE 10 2009 046 375 A1 a steering system for a vehicle is known which has a coupling element in the transmission path between a steering wheel and the point acted upon by a servo unit, which coupling element can be adjusted between a closed position in which it transmits a steering motion and a de-coupled open position. In the closed position a continuous transmission path is established between the steering wheel and the steerable wheels so that steering motions generated by the driver are transmitted in a conventional manner. In the de-coupled open position of the coupling element, the transmission path is interrupted in the region between the steering wheel and the servo unit. The transmission path between the servo unit and the wheels remains closed in the open position so that the servo unit can generate a steering motion, which is transmitted to the wheels.

It would therefore be desirable and advantageous to provide an improved to obviate prior art shortcomings and to provide an adaptive crash structure for a vehicle, which offers an effective passenger protection in the case of a laterally offset front impact while only slightly increasing weight.

### SUMMARY OF THE INVENTION

According to one aspect of the present invention, an adaptive crash structure for a vehicle includes a deformation element arranged in a region of a wheel housing of the vehicle, and an interruption system, wherein the deformation element and the interruption system are constructed so as to be able to change from a deactivated state to an activated state, wherein in the deactivated state the deformation element permits movement of a wheel housed in the wheel housing, and wherein in the activated state the deformation element causes the wheel to assume a predetermined position and the interruption system prevents a change of the position of the wheel to be transmitted to a steering wheel.

Such an adaptive crash structure offers an effective passenger protection, in particular in the case of a laterally offset front impact at low weight increase of the adaptive crash structure. As a result of the deformation element, which is preferably arranged in the foot region of a transverse member, the foot region is additionally protected and a sliding away of the vehicle from the collision partner is enabled by the predetermined wheel position. Advantageously the predetermined wheel position is capable of moving the vehicle away from a penetrating object. As a result the impact angle and the distance to the penetrating object can be changed which allows reducing the forces that act in the direction of the passenger compartment, wherein the crash energy which acts on the passenger compartment can advantageously further be reduced. The interruption system allows interrupting the transmission of the wheel position change to the steering wheel. Advantageously in case of a provoked change of the wheel position, no rotational motion at the steering wheel can occur, which allows reducing the risk of injury for the passengers. In addition, the deformation element can advantageously absorb impact energy by deformation. Thus the risk of injury to the passengers can advantageously be reduced in the case of laterally offset frontal impact accidents, without for example introducing additional stiffening elements in the region of the foot space, which would increase the weight of the vehicle. In the deactivated state, the deformation element permits movement of the wheel. This means that the energy absorbing component during normal operation does not influence the steering motions of the wheels.

According to another advantageous feature of the invention, the adaptive crash structure according can further include at least one pyrotechnic system constructed to ignite in response to a control signal and thereby causing the deformation element and the interruption system to assume the activated state. Advantageously the reaction time between recognizing a relevant accident situation and activation of the deformation element and the interruption system can thus be decreased. The pyrotechnic system can be configured as pyrotechnic actuator, which orients the deformation element. In addition the at least one pyrotechnic system can include at least one detonator which is assigned to the interruption system and interrupts at least one mechanical connection between the steering wheel and the wheel. Advantageously a pyrotechnic unlocking of the connection between the steering wheel and the wheel and a targeted lateral offset of a longitudinal control arm an angled position of the wheel can be achieved, wherein in a preferred embodiment in a region of the wheel which points in driving direction points towards the center of the vehicle and a region of the wheel which points in the direction opposite the driving direction points away from the vehicle.

According to another advantageous feature of the invention, the deformation element in the activated state can form a deflection group with at least one deflection slant, wherein the at least one deflection slant is oriented in a predetermined angle relative to the longitudinal direction of the vehicle and causes the wheel to assume the predetermined wheel position and deflects penetrating objects in the predetermined direction. Advantageously the deformation element in the activated state can cause a wheel which is arranged in the wheel housing and is moved by the crash energy in the direction of the deformation element, to assume a predetermined wheel position via the at least one deflection slant. This means that the wheel that was moved by the crash energy is deflected on the deflection slant of the deformation element and does thus advantageously not penetrate into the foot space. Further, a side of the wheel that was caused to assume the predetermined new position can advantageously form an additional deflection surface of the deflection group, which enables a deflection of the collision partner or the penetrating object away from the vehicle. In addition, a block dimension between passenger compartment and collision partner or respectively entering object can advantageously be used.

According to another advantageous feature of the invention, the interruption system can interrupt a mechanical connection between a chassis sub frame and a lower longitudinal control arm. In addition the interruption system can interrupt a mechanical connection between a steering linkage and a wheel control arm. With this the wheel position change can advantageously be prevented to be transmitted to a steering wheel.

According to another advantageous feature of the invention, at least one crash sensor can be provided whose signals are analyzed by an analysis and control unit for outputting the control signal, wherein the analysis and control unit outputs the control signal for activating the deformation element and the interruption system. The analysis and control unit can output the control signal for activating the deformation element and/or interruption system when a laterally offset frontal impact of an external object is recognized and/or an impact probability of an external object in the laterally offset front region is detected. Preferably the deformation element and/or the interruption system can be triggered via crash sensors already present in the vehicle, which crash sensors are for example arranged on the vehicle front so that advantageously no further costs are incurred.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of a triggering function for activating a deflection group and of an interruption system for a first exemplary embodiment of an adaptive crash structure according to the invention for a vehicle,

FIG. 2 shows a schematic diagram of a triggering function for activating a deflection group and of an interruption system for a second exemplary embodiment of an adaptive crash structure according to the invention for a vehicle,

FIG. 3 shows a schematic top view onto the first exemplary embodiment of an adaptive crash structure according to the invention for a vehicle shown in FIG. 1 in a deactivated state,

FIG. 4 shows a schematic top view onto the second exemplary embodiment of an adaptive crash structure according to the invention shown in FIG. 2 in an activated state.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

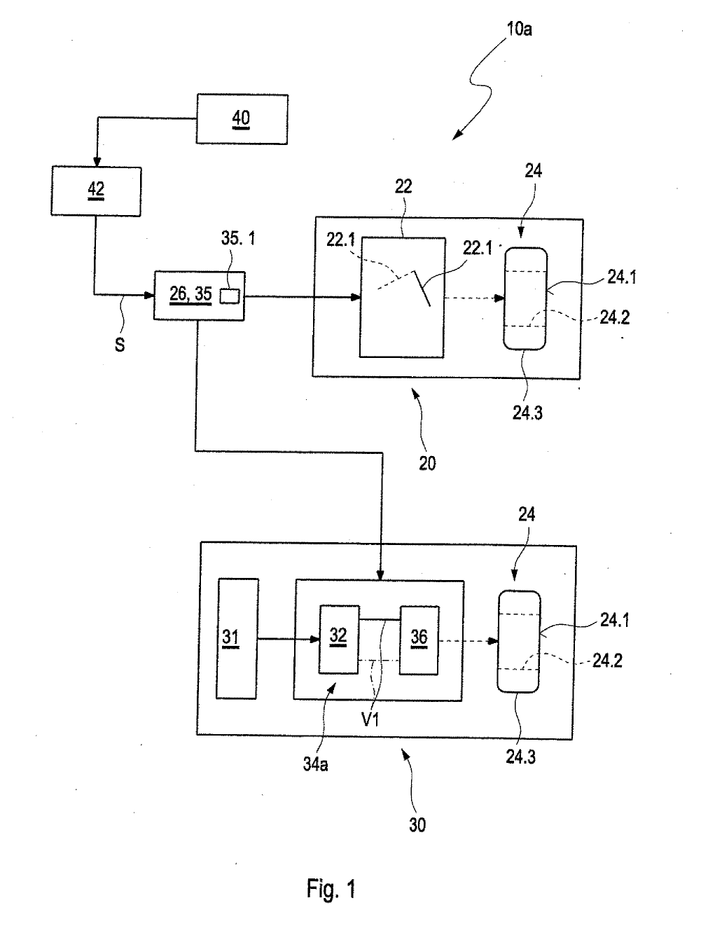

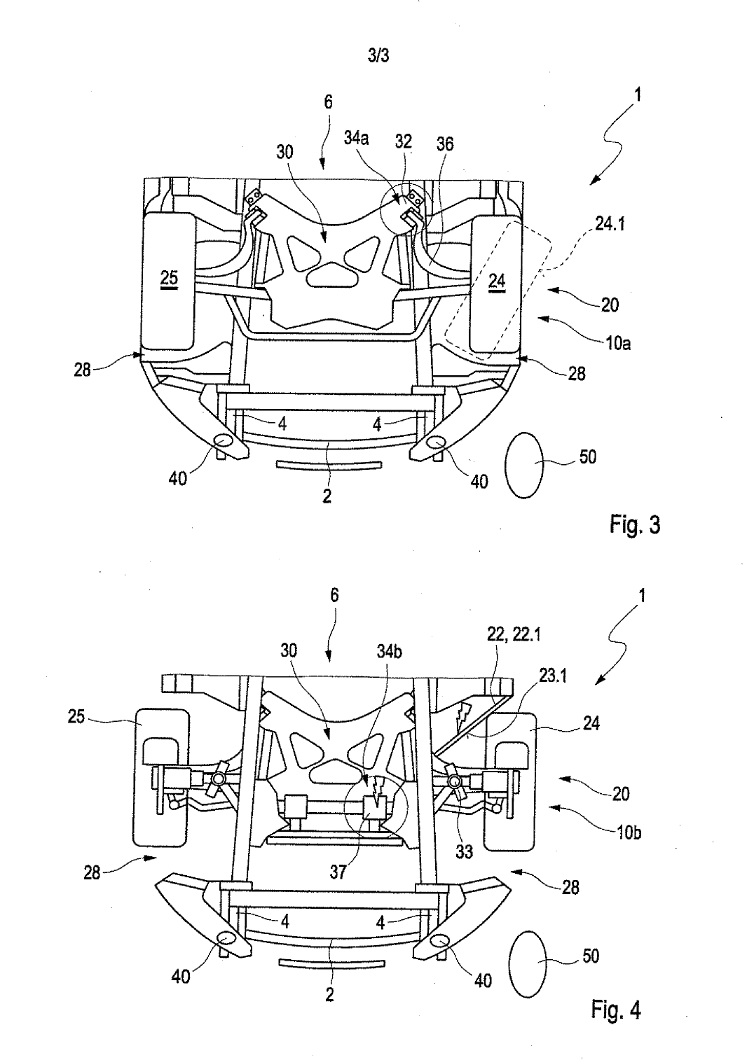

Turning now to the drawing, and in particular to FIGS. 1-4, there is shown an adaptive crash structure 10a, 10b for a vehicle 1, which adaptive crash structure has a deformation element 22 in the region of a wheel housing 28, which deformation element 22 permits in a deactivated state shown in FIG. 3 movement of a wheel 24 and in an activated state shown in FIG. 4 absorbs crash energy.

As can be further seen in FIGS. 1 to 4, a steering system 30 has a steering wheel 31 or another steering means, at least one steering linkage 33, at least one longitudinal control arm 36, a steering transmission 37 and at least one wheel 24. Wherein the elements of the steering system 30 are coupled with each other so that a movement of the steering wheel 31 is transmitted to the wheel 24 via corresponding operative connections and the wheel is caused to assume a corresponding wheel position. Correspondingly a change of the wheel position is transmitted to the steering wheel 31.

According to the invention, the deformation element 22 in the activated state causes a wheel 24 arranged in the wheel housing 28 to assume a predetermined wheel position, wherein an interruption system 34a, 34b prevents the wheel position change to be transmitted to the steering wheel.

As can be seen from FIGS. 1 to 4, the deformation element 22 in the activated state forms a deflection group 20 with at least one deflection slant 22.1 which is oriented in a predetermined angle relative to the longitudinal direction of the vehicle and deflects the entering object 50 into this predetermined direction.

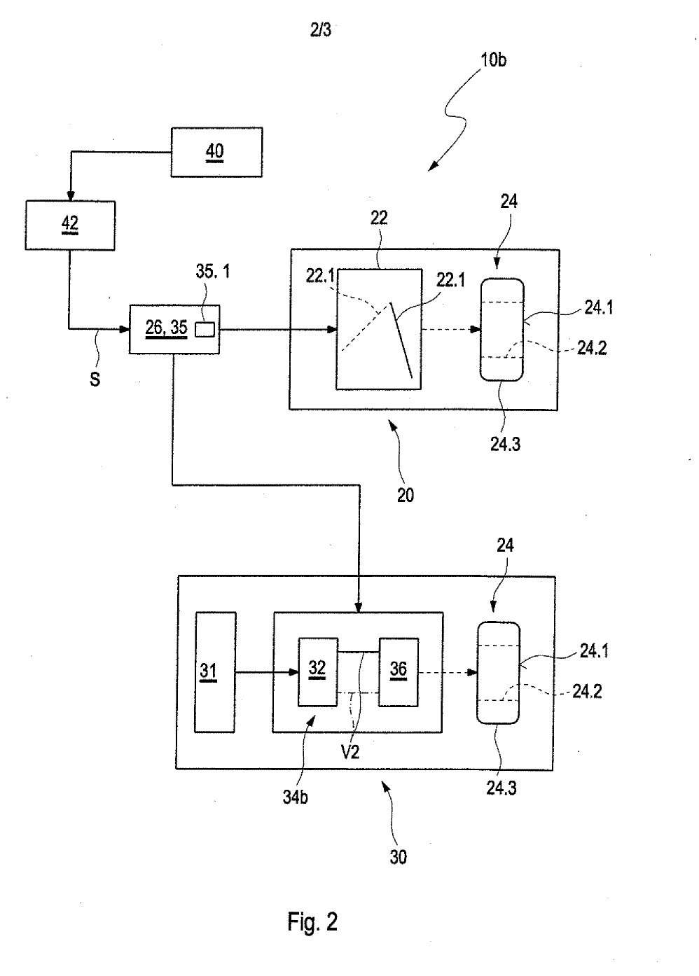

As can be further seen from FIGS. 1 and 2, the deformation element 22 is configured as slant with a leg 22.1, wherein the leg 22.1 is rotatably supported in an end region on the wheel housing 28. The deformation element 22 is activated by a pyrotechnic system 26, wherein the control signal S outputted by the analysis and control unit 42 ignites the pyrotechnic system 26. The pyrotechnic system 26 can be configured as pyrotechnic actuator. The leg 22.1 of the deformation element 22 can be caused by the pyrotechnic system to assume an activated state shown in dashed lines. Further, not shown embodiments of the deformation element are configured as hinge with two legs, one leg of which forms a deflection slant or is configured as finable body which in the filled state forms a deflection slant.

As can be seen further from FIGS. 1 and 2, the interruption system 34a, 34b is activated by a pyrotechnic system 35. The pyrotechnic system 35 includes at least one detonator 35.1 which is assigned to the interruption system 34a, 34b and interrupts at least one mechanical connection V1, V2 and/or an operative connection between the steering wheel 31 and the wheel 24.

In the shown exemplary embodiments, the adaptive crash structure has a pyrotechnic system 26, 35 which activates the deformation element and the interruption system. An embodiment is also conceivable, however, in which the deformation element and the interruption system each have a separate pyrotechnic system.

As can be seen from FIGS. 1 to 4 the shown exemplary embodiments differ from each other with regard to the configuration of the interruption system 34a, 34b. The interruption system 34a shown in FIG. 1 interrupts an operative connection V1 between a chassis sub frame 32 and a lower longitudinal control arm 36, wherein the pyrotechnic unlocking of the connection V1 between the chassis sub frame 32 and the lower longitudinal steering arm 36 allows achieving an additional targeted lateral offset of the longitudinal control arm 36 which can effect an additional transverse positioning of the wheel 24. The interruption system 34b shown in FIGS. 2 and 4 interrupts an operative connection V2 between a steering linkage 33 and a steering transmission 37. Both exemplary embodiments enable a decoupling of the wheel 24 from the steering wheel 31 so that the change of the wheel position caused by the deformation element 22 is not transmitted to the steering wheel 31. In addition an occupant can no longer intervene via the steering wheel 31, in this way it can be prevented that an occupant changes the wheel position or suffers injury from the steering wheel 31 which would transmit the rotational movement of the wheel 24 in the absence of decoupling.

As can be further seen from FIGS. 1 to 4 crash sensors 40 are provided, which in the shown exemplary embodiment are arranged in the front region of the vehicle 1. Signals of the crash sensors 40 are analyzed by an analysis and control unit 42 for outputting a control signal S. For this, the analysis and control unit 42 outputs the control signal S for activating the deformation element 22 and the interruption system 34a, 34b when a laterally offset frontal impact of an object 50 is recognized by the analysis and/or a laterally offset impact probability of an object 50 is determined. The crash sensors 40 can for example be configured as acceleration sensors. For the analysis different threshold values can be predetermined, wherein when exceeding and/or falling below at least one threshold value a lateral impact and/or a lateral impact probability can be recognized so that the analysis and control unit 42 outputs the control signal S. The analysis and control unit 42 can also be part of another safety device such as an airbag control system for the driver airbag and/or the passenger airbag.

As can be further seen from FIGS. 3 and 4, the vehicle 1 in the shown front region includes a bumper 2, which extends perpendicular to a longitudinal direction of the vehicle and is arranged between two longitudinal members 4 of the vehicle 1. The wheel housings 28 are arranged adjacent to the longitudinal members 4, wherein the deformation elements 22 are arranged at the height of the bumper 2 and the longitudinal member 4 in the respective wheel housing 28.

As can be further seen from FIGS. 3 and 4 the deformation element 22 of the right hand wheel housing 28 restricts in the activated state the wheel movement of the wheel 24, wherein the leg 22.1 in the activated state forms a deflection slant 23.1 which has a predetermined angle relative to the longitudinal direction of the vehicle.

As can be further seen from FIGS. 3 and 4, the deformation element 22 in the activated state can cause a wheel 24 which is arranged in the wheel housing 28 and was moved by the crash energy in the direction of the deformation element 22, to assume a predetermined wheel position via the at least one deflection slant 23.1. The at least one deflection slant 23.1 causes hereby a “twisting out” of the wheel 24, whereby the block dimension between the foot space 6 and the entering object 50 is reduced. In addition the at least one deflection slant 22.1 also leads to a deflection of the object that enters the vehicle 1.

As can be further seen from FIG. 4, the deformation element 22 can assume a wedge shape, wherein the deformation element 22 is arranged between the wheel 24 and the corresponding wheel housing 28. Depending on the configuration the deformation element 22 can fix the wheel 24 in a predetermined wheel position.

In the state shown in FIG. 4 the deformation element 22 in the right hand wheel housing 28 is in the activated state, wherein the object 50 has not yet entered and the wheel 24 has not yet been moved by the crash energy. In the case of an entering of the object 50, the wheel 24 is pushed by the crash energy onto the at least one deflection slant 23.1 and deflected by the deflection slant and with this caused to assume a predetermined wheel position. The predetermined wheel position can move the vehicle 1 additionally away from the entering object 50.

A wheel side which faces away from the vehicle 1 can form an additional deflection surface 24.1 of the deflection group 20. Here, the additional deflection surface 24.1 is formed by a wheel rim 24.2 of the wheel 24, which usually is manufactured from metal, for example aluminum, steel etc. and a tire mantel.

As can be further seen from FIGS. 3 and 4 the deflection device 20 of the crash structure 10a, 10b according to the invention prevents in case of accidents with small overlap relative to the rash partner 50 an introduction of occurring forces via the wheel rim 24.2 into the foot space 6 of the vehicle without necessitating arranging additional stiffening elements in the region of the foot space 6. In addition no rotation occurs on the steering wheel 31 in case of a provoked change of the wheel kinematic, which reduces the risk of injury for passengers.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An adaptive crash structure for a vehicle, comprising:
a deformation element arranged in a region of a wheel housing of the vehicle; and
an interruption system, said deformation element and said interruption system constructed so as to be able to change from a deactivated state to an activated state, wherein in the deactivated state the deformation element permits movement of a wheel housed in the wheel housing, and wherein in the activated state the deformation element causes the wheel to assume a predetermined position and the interruption system prevents a change of the position of the wheel to be transmitted to a steering wheel.

2. The adaptive crash structure of claim 1, further comprising at least one pyrotechnic system constructed to ignite in response to a control signal and thereby causing the deformation element and the interruption system to assume the activated state.

3. The adaptive crash structure of claim 2, wherein the at least one pyrotechnic system includes at least one detonator which is assigned to the interruption system and interrupts at least one mechanical connection between the steering wheel and the wheel.

4. The adaptive crash structure of claims 1, wherein the deformation element in the activated state forms a deflection group having at least one deflection slant, said least one deflection slant being oriented at a predetermined angle relative to a longitudinal direction of the vehicle, said wheel being caused to assume the predetermined wheel position and deflecting an entering object in the predetermined direction.

5. The adaptive crash structure of claim 4, wherein a surface of the wheel which faces away from the vehicle forms an additional deflection surface of the deflection group.

6. The adaptive crash structure of claim 1, wherein the interruption system interrupts an operative connection between a chassis sub frame and a lower longitudinal control arm.

7. The adaptive crash structure of claim 1, 5 wherein the interruption system interrupts an operative connection between a steering linkage and a steering transmission.

8. The adaptive crash of claims 1, further comprising at least one crash sensor and an analysis and control unit, said analysis and control unit constructed for performing an analysis of signals produced by the at least one crash sensor and for outputting a control signal for activating the deformation element and the interruption system, wherein the analysis and control unit outputs the control signal when the analysis indicates at least one of a laterally offset frontal impact of an external object and a probability of an impact of an external object in a laterally offset front region of the vehicle.

9. A vehicle comprising an adaptive crash structure, said adaptive crash structure is comprising a deformation element arranged in a region of a wheel housing, which deformation element in a deactivated state permits a wheel motion, wherein the deformation element in the activated state causes a wheel arranged in the wheel housing to assume a predetermined wheel position, and wherein an interruption system prevents a transmission of a change of the wheel position to a steering wheel
